(19) United States
(12) Patent Application Publication
(10) Pub. No.: US 2026/0019518 A1
(43) Pub. Date: Jan. 15, 2026

(54) INFORMATION PROCESSING APPARATUS, INFORMATION PROCESSING METHOD, AND INFORMATION PROCESSING PROGRAM

(71) Applicant: FUJIFILM Corporation, Tokyo (JP)

(72) Inventors: Shotaro MISAWA, Tokyo (JP); Ryuji KANO, Tokyo (JP); Hirokazu YARIMIZU, Tokyo (JP); Tomoki TANIGUCHI, Tokyo (JP); Kohei ONODA, Tokyo (JP)

(73) Assignee: FUJIFILM Corporation, Tokyo (JP)

(21) Appl. No.: 19/329,605

(22) Filed: Sep. 16, 2025

Related U.S. Application Data
(63) Continuation of application No. PCT/JP2024/000193, filed on Jan. 9, 2024.

(30) Foreign Application Priority Data
Mar. 31, 2023 (JP) 2023-058030

(51) Int. Cl. H04N 1/00; G06V 30/414; G06V 30/416

(52) U.S. Cl. CPC H04N 1/00824; G06V 30/414; G06V 30/416; H04N 1/00442

(57) ABSTRACT

An information processing apparatus acquires a plurality of pieces of document data, each including a plurality of partial documents, and date information associated with each of the plurality of pieces of document data, derives partial document relationship information representing a relationship between the partial documents, based on a similarity between the partial documents and the date information, among the plurality of pieces of document data, and derives overall document relationship information representing an overall relationship among the plurality of pieces of document data, based on the partial document relationship information.

### CROSS-REFERENCE TO RELATED APPLICATIONS

This application is a continuation application of International Application No. PCT/JP2024/000193, filed Jan. 9, 2024, the disclosure of which is incorporated herein by reference in its entirety. Further, this application claims priority from Japanese Patent Application No. 2023-058030, filed Mar. 31, 2023, the disclosure of which is incorporated herein by reference in its entirety.

### BACKGROUND

### 1. Technical Field

The present disclosure relates to an information processing apparatus, an information processing method, and an information processing program.

### 2. Description of the Related Art

JP1999-053387A (JP-H11-053387A) discloses a technology of associating a plurality of pieces of document data ordered in time series based on a similarity between the plurality of pieces of document data.

### SUMMARY

In the technology disclosed in JP1999-053387A (JP-H11-053387A), since the similarity between the plurality of pieces of document data is calculated by comparing the entire document data, there is room for improvement in precision of association between the plurality of pieces of document data.

The present disclosure has been made in view of the above circumstances, and an object of the present disclosure is to provide an information processing apparatus, an information processing method, and an information processing program capable of associating a plurality of pieces of document data with high precision.

An information processing apparatus according to the present disclosure comprises: at least one processor, in which the processor is configured to acquire a plurality of pieces of document data, each including a plurality of partial documents, and date information associated with each of the plurality of pieces of document data, derive partial document relationship information representing a relationship between the partial documents, based on a similarity between the partial documents and the date information, among the plurality of pieces of document data, and derive overall document relationship information representing an overall relationship among the plurality of pieces of document data, based on the partial document relationship information.

In addition, an information processing method according to the present disclosure is executed by a processor provided in an information processing apparatus, the information processing method comprising: acquiring a plurality of pieces of document data, each including a plurality of partial documents, and date information associated with each of the plurality of pieces of document data; deriving partial document relationship information representing a relationship between the partial documents, based on a similarity between the partial documents and the date information, among the plurality of pieces of document data; and deriving overall document relationship information representing an overall relationship among the plurality of pieces of document data, based on the partial document relationship information.

In addition, an information processing program according to the present disclosure causes a processor provided in an information processing apparatus to execute: acquiring a plurality of pieces of document data, each including a plurality of partial documents, and date information associated with each of the plurality of pieces of document data; deriving partial document relationship information representing a relationship between the partial documents, based on a similarity between the partial documents and the date information, among the plurality of pieces of document data; and deriving overall document relationship information representing an overall relationship among the plurality of pieces of document data, based on the partial document relationship information.

According to the present disclosure, it is possible to associate the plurality of pieces of document data with high precision.

### BRIEF DESCRIPTION OF THE DRAWINGS

FIG. 1 is a block diagram showing an example of a hardware configuration of an information processing apparatus.

FIG. 2 is a diagram for describing document data.

FIG. 3 is a diagram for describing date information.

FIG. 4 is a block diagram showing an example of a functional configuration of the information processing apparatus.

FIG. 5 is a diagram for describing a process of deriving partial document relationship information.

FIG. 6 is a diagram for describing a process of deriving the partial document relationship information.

FIG. 7 is a diagram for describing a process of deriving overall document relationship information.

FIG. 8 is a diagram for describing a process of deriving the overall document relationship information.

FIG. 9 is a diagram showing an example of a display screen.

FIG. 10 is a diagram showing an example of a display screen according to a modification example.

FIG. 11 is a diagram showing an example of a display screen according to a modification example.

FIG. 12 is a diagram showing an example of a display screen according to a modification example.

FIG. 13 is a diagram showing an example of a display screen according to a modification example.

FIG. 14 is a diagram showing an example of a display screen according to a modification example.

FIG. 15 is a diagram showing an example of a display screen according to a modification example.

FIG. 16 is a flowchart showing an example of a relationship information derivation process.

FIG. 17 is a diagram showing an example of a display screen according to a modification example.

FIG. 18 is a diagram showing an example of a display screen according to a modification example.

FIG. 19 is a diagram showing an example of a display screen according to a modification example.

### DESCRIPTION OF THE PREFERRED EMBODIMENTS

Hereinafter, an embodiment for carrying out the technology of the present disclosure will be described in detail with reference to the drawings.

First, a hardware configuration of an information processing apparatus 10 according to the present embodiment will be described with reference to FIG. 1. Examples of the information processing apparatus 10 include a computer such as a personal computer or a server computer. As shown in FIG. 1, the information processing apparatus 10 includes a central processing unit (CPU) 20, a memory 21, a storage unit 22, a display 23, an input device 24, and a network interface (I/F) 25.

The CPU 20 executes a program stored in the storage unit 22, which will be described below, to realize a functional configuration, which will be described below. The CPU 20 is an example of a processor according to the disclosed technology.

The memory 21 includes the storage unit 22 and a random access memory (RAM) 26. The RAM 26 is a primary storage memory, and is, for example, a RAM such as a static random access memory (SRAM) or a dynamic random access memory (DRAM).

The storage unit 22 is a non-volatile memory, and is implemented by, for example, at least one of a hard disk drive (HDD), a solid state drive (SSD), or a flash memory. An information processing program 30 is stored in the storage unit 22 as a storage medium. The CPU 20 reads out the information processing program 30 from the storage unit 22, loads the readout information processing program 30 into the memory 21, and executes the loaded information processing program 30.

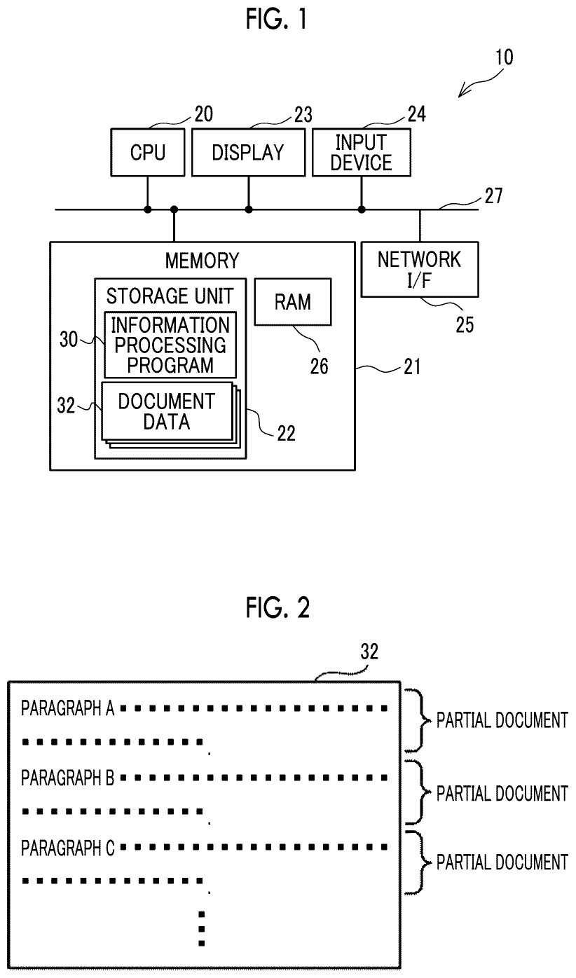

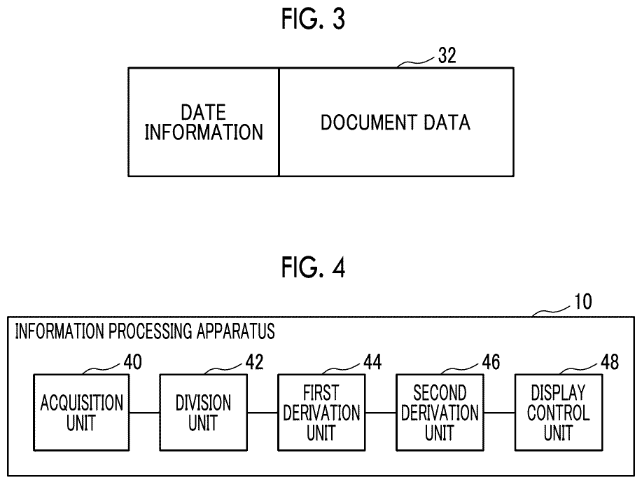

In addition, a plurality of pieces of document data 32 are stored in the storage unit 22. As shown in FIG. 2, each of the plurality of pieces of document data 32 includes a plurality of paragraphs as an example of a partial document. The partial document is not limited to a paragraph, and may be a page, a sentence, a section, a word, or the like. In addition, as shown in FIG. 3, each piece of document data 32 is associated with date information. The date information represents, for example, a date on which the associated document data 32 is created. In addition, for example, in a case of making corrections or other updates to a document, a latest updated version of the document and a latest update date may be stored as the document data 32 and the date information associated with the document data 32, or the latest updated version of the document and a date on which the document was first created may be stored as the document data 32 and the date information associated with the document data 32. In addition, for each updated document, the updated document and the update date may be stored as the document data 32 and the date information associated with the document data 32.

The display 23 is a device that displays various screens under the control of the CPU 20, and is, for example, a liquid crystal display or an electro luminescence (EL) display. The input device 24 is a device for a user to perform input, and is, for example, at least any of a keyboard, a mouse, a microphone for voice input, a touch pad for close contact input including contact, or a camera for gesture input. The network I/F 25 is an interface for connection to a network. A bus 27 connects the CPU 20, the memory 21, the storage unit 22, the display 23, the input device 24, and the network I/F 25 to each other.

Next, a functional configuration of the information processing apparatus 10 will be described with reference to FIG. 4. As shown in FIG. 4, the information processing apparatus 10 includes an acquisition unit 40, a division unit 42, a first derivation unit 44, a second derivation unit 46, and a display control unit 48. The CPU 20 executes the information processing program 30 to function as the acquisition unit 40, the division unit 42, the first derivation unit 44, the second derivation unit 46, and the display control unit 48.

The acquisition unit 40 acquires the plurality of pieces of document data 32 and the date information associated with each of the plurality of pieces of document data 32 from the storage unit 22.

The division unit 42 divides each of the plurality of pieces of document data 32 acquired by the acquisition unit 40 into a plurality of partial documents.

The first derivation unit 44 derives partial document relationship information representing a relationship between the partial documents, based on a similarity between the partial documents divided by the division unit 42 and the date information, among the plurality of pieces of document data 32 acquired by the acquisition unit 40. Hereinafter, a specific example of a process of deriving the partial document relationship information using the first derivation unit 44 will be described.

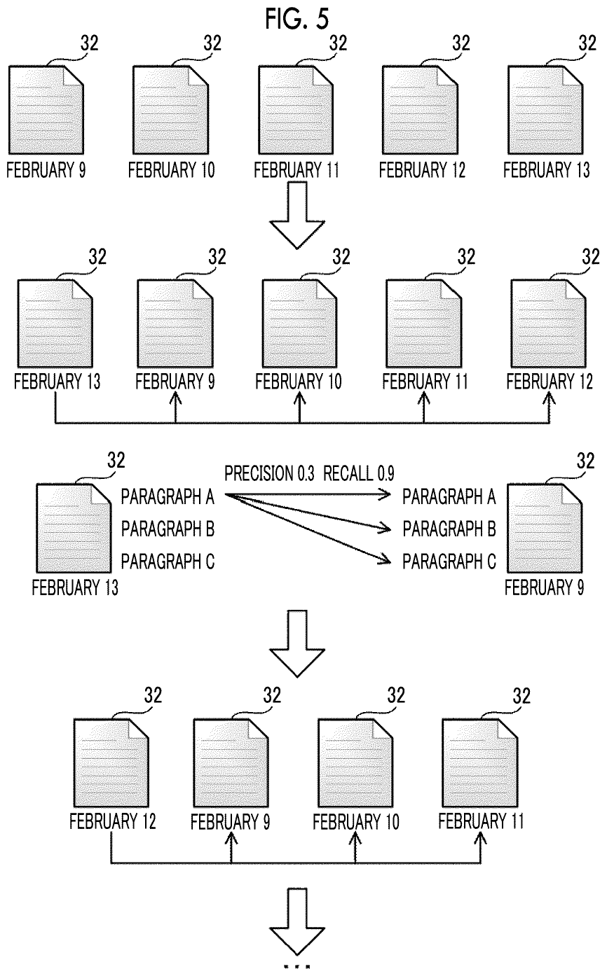

As shown in FIG. 5, starting from the document data 32 whose date indicated by the date information is the newest date, the first derivation unit 44 uses one piece of the document data 32 as a reference and derives a similarity between the partial documents between the reference document data 32 and the document data 32 whose date indicated by the date information is older than that of the reference document data 32. In the example of FIG. 5, first, the first derivation unit 44 uses the document data 32 dated February 13 as a reference and derives a similarity between the partial documents between the reference document data 32 and each of the pieces of document data 32 dated February 9 through February 12. Next, the first derivation unit 44 uses the document data 32 dated February 12 as a reference and derives a similarity between the partial documents between the reference document data 32 and each of the pieces of document data 32 dated February 9 through February 11. The first derivation unit 44 performs the same process on each of the pieces of document data 32 dated February 11 and February 10. Starting from the document data 32 whose date indicated by the date information is the oldest date, the first derivation unit 44 may use one piece of the document data 32 as a reference and derive a similarity between the partial documents between the reference document data 32 and the document data 32 whose date indicated by the date information is newer than that of the reference document data 32.

In the present embodiment, an example in which a precision and a recall between the partial documents are applied as the similarity between the partial documents will be described. The precision is an index value that indicates to what extent the content of the partial document in the reference document data 32 is covered by a corresponding partial document in the document data 32 to be compared. The recall is an index value that indicates to what extent the content of the partial document in the document data 32 to be compared is covered by the corresponding partial document in the reference document data 32. The similarity between the partial documents is not limited to the precision and the recall, and may be an edit distance, a bilingual evaluation understudy (BLEU), a Recall-Oriented Understudy for Gisting Evaluation (ROUGE), a bidirectional encoder representations from transformers (BERT) score, or the like.

For example, the fact that a precision with respect to a paragraph A of the document data 32 dated February 9 is 0.3 in a case where a paragraph A of the document data 32 dated February 13 is used as a reference means that 30% of the content of the paragraph A of the document data 32 dated February 13 is written in the paragraph A of the document data 32 dated February 9. In addition, the fact that a recall with respect to the paragraph A of the document data 32 dated February 9 is 0.9 in a case where the paragraph A of the document data 32 dated February 13 is used as the reference indicates that 90% of the content of the paragraph A of the document data 32 dated February 9 is written in the paragraph A of the document data 32 dated February 13. In this case, the document data 32 dated February 13 is considered to be a version in which content has been added to the paragraph A of the document data 32 dated February 9, that is, a version with added content.

The first derivation unit 44 derives, for each partial document of the reference document data 32, the precision and the recall with respect to each paragraph of the document data 32 to be compared. Then, the first derivation unit 44 adopts the highest precision and the highest recall among values of the precision and the recall, as the precision and recall of each partial document of the reference document data 32 with respect to the document data 32 to be compared. In this case, the first derivation unit 44 may adopt the precision and the recall with the largest average or the largest total value of the precision and the recall, as the precision and recall of each partial document of the reference document data 32 with respect to the document data 32 to be compared.

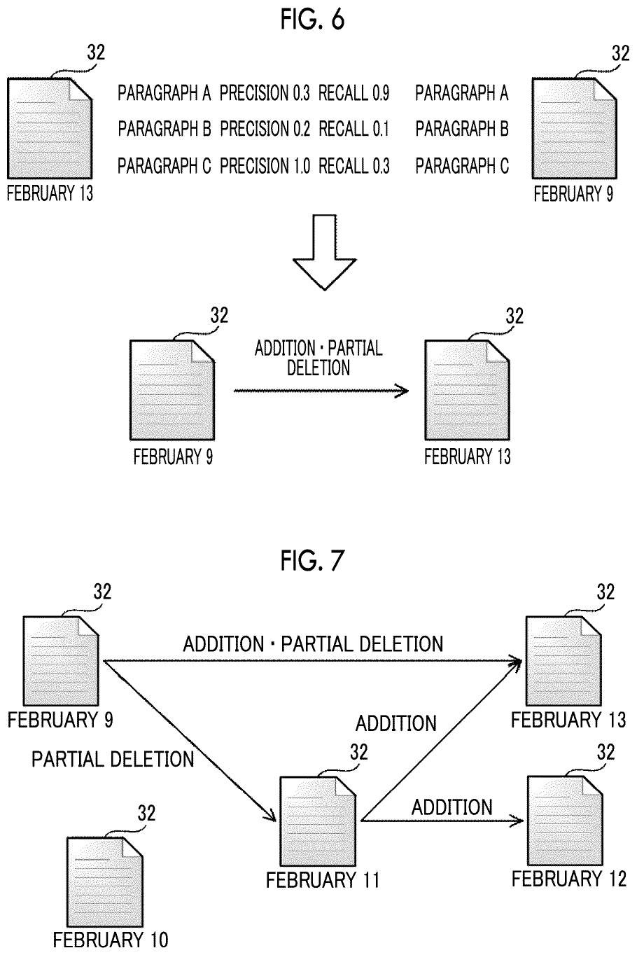

As shown in FIG. 6, the first derivation unit 44 derives any one of a plurality of categories representing the relationship between the partial documents as the partial document relationship information representing the relationship between the partial documents, based on the derived precision and recall, and the date information. In the present embodiment, the first derivation unit 44 derives any one of the following categories (1) to (5) as the partial document relationship information representing the relationship from the partial document of the document data 32 whose date is relatively old to the document data 32 whose date is relatively new, based on the derived precision and recall. (1) to (4) are categories in which the partial documents are related to each other, and (5) is a category in which the partial documents are not related to each other.
(1) Addition: This indicates that a partial document is created by adding content to an existing partial document.
(2) Compile: This indicates that a partial document is created by compiling a plurality of existing partial documents.
(3) Correction: This indicates that a partial document is created by correcting a sentence of an existing partial document.
(4) Deletion: This indicates that a partial document is created by deleting a part of an existing partial document.
(5) New: This indicates that a partial document has no relationship and is newly created based on any information other than an existing partial document.

Specifically, in a case where the precision is less than a threshold value and the recall is equal to or greater than a threshold value, the first derivation unit 44 derives “addition” as the partial document relationship information. In addition, in a case where the precision is equal to or greater than the threshold value and the recall is less than the threshold value, the first derivation unit 44 derives “deletion” as the partial document relationship information. In addition, in a case where the precision is equal to or greater than the threshold value, the recall is equal to or greater than the threshold value, and a difference between the precision and the recall is within an allowable range, the first derivation unit 44 derives “correction” as the partial document relationship information. In the present embodiment, “transcription” in which the recall and the precision are both 1.0 is also included in “correction”. It should be noted that “transcription” may be classified as a different category from “correction”. In addition, in a case where the precision is less than the threshold value and the recall is less than the threshold value, the first derivation unit 44 derives “new” as the partial document relationship information. In addition, in a case where there are two or more pieces of the relatively old document data 32 in which the precision derived for the partial document in the relatively new document data 32 is less than the threshold value and the recall is equal to or greater than the threshold value, the first derivation unit 44 derives “compile” as the partial document relationship information. In addition, in a case where the combination of the precision and the recall does not correspond to any of “addition”, “compile”, “correction”, and “deletion”, the first derivation unit 44 may derive “new” as the partial document relationship information.

The second derivation unit 46 derives overall document relationship information representing an overall relationship among the plurality of pieces of document data 32 based on the partial document relationship information derived by the first derivation unit 44. As shown in FIG. 7, in the present embodiment, the second derivation unit 46 derives the overall document relationship information by linking the partial document relationship information derived between all combinations of the document data 32. In addition, as a method of deriving the overall document relationship information from the partial document relationship information, for example, the second derivation unit 46 may use the categories of the partial document relationship information included in the document data 32, with duplicates removed, as the overall document relationship information. In addition, the second derivation unit 46 may use, as the overall document relationship information, the categories of the partial document relationship information that remain after excluding the “new” category, that is, a relationship whose similarity is equal to or less than a predetermined threshold. For example, in a case where the document data 32 includes a partial document A whose partial document relationship information is “addition”, a partial document B whose partial document relationship information is “new”, and a partial document C whose partial document relationship information is “addition”, the second derivation unit 46 derives the overall document relationship information as “addition”. In addition, the second derivation unit 46 may use the partial document relationship information and a proportion of the partial documents of the partial document relationship information to the entirety of the document data 32 as the overall document relationship information. For example, in a case where there is document data 32 consisting of paragraphs A to D, and the partial document relationship information is such that the paragraph A and the paragraph C are “addition”, the paragraph B is “new”, and the paragraph D is “correction”, the second derivation unit 46 may set the overall document relationship information as “addition: 0.5, new: 0.25, correction: 0.25”. Further, the second derivation unit 46 may exclude, from among the categories of the partial document relationship information, any category in which the proportion with respect to the entirety of the document data 32 is equal to or less than a predetermined threshold. For example, in the above case, the second derivation unit 46 may exclude any category in which the proportion is less than 0.5 and use only “addition: 0.5” as the overall document relationship information. As an example of the proportion of the partial documents to the entirety of the document data 32, the number of paragraphs for each category of the partial document relationship information relative to the total number of paragraphs in the document data 32 has been used, but the present disclosure is not limited to this, and it may also be the number of characters in the partial documents for each category of the partial document relationship information relative to the total number of characters.

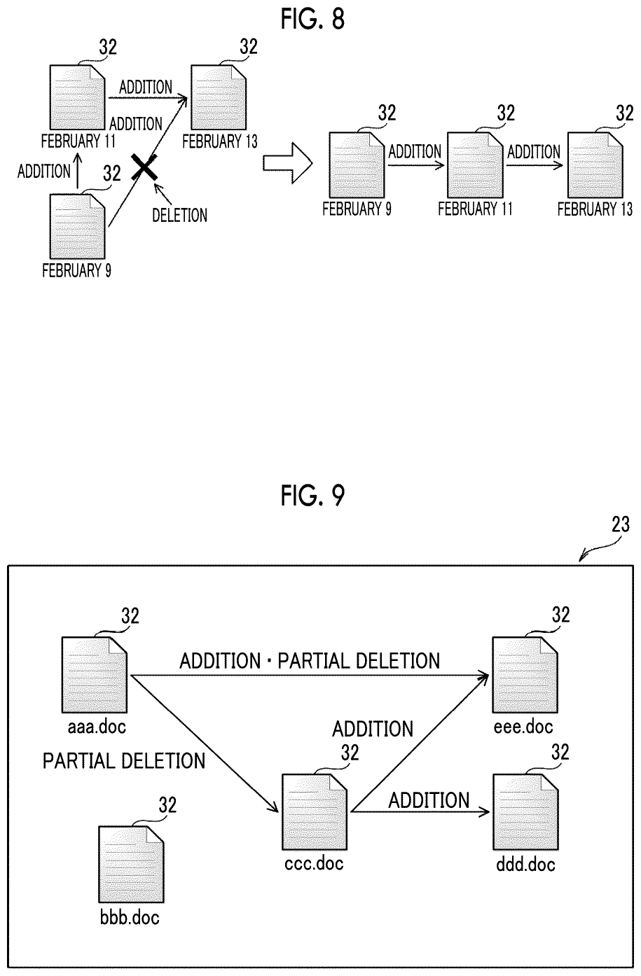

As shown in FIG. 8, as the partial document relationship information, in a case where it is derived that one piece of the document data 32 whose date is relatively new has a relationship with the plurality of pieces of document data 32 whose date is relatively old and that relationships also exist among the plurality of pieces of document data 32, the second derivation unit 46 may delete a relationship derived based on a relatively low similarity among the relationships between the one piece of document data 32 and the plurality of pieces of document data 32. The second derivation unit 46 may delete the relationship derived based on the relatively low similarity only in a case where the relationships between the one piece of document data 32 and the plurality of pieces of document data 32 are common. The case where the relationships between the one piece of document data 32 and the plurality of pieces of document data 32 are common indicates, for example, a case where at least a part of the overall document relationship information is common, or a case where the partial document associated with the partial document relationship information that is the basis of the overall document relationship information is common. For example, in a case where the partial document included in the document data 32 dated February 9 in the partial document relationship information serving as the basis for the overall document relationship information “addition” between the document data 32 dated February 9 and the document data 32 dated February 11 is the same as the partial document included in the document data 32 dated February 9 in the partial document relationship information serving as the basis for the overall document relationship information “addition” between the document data 32 dated February 9 and the document data 32 dated February 13, the second derivation unit 46 deletes the overall document relationship information between the partial document dated February 11 and a similarity between the same partial document and the partial document dated February 13 that indicates a lower one of a similarity between the same partial document and the partial document dated February 11 and a similarity between the same partial document and the partial document dated February 13. In addition, in a case where one piece of the document data 32 has a relationship with the plurality of pieces of document data 32 and the plurality of pieces of document data 32 having the relationship are related to each other, the second derivation unit 46 may delete a relationship with the document data 32 associated with the older date information among the plurality of pieces of document data 32 having the relationship. For example, in a case where the document data 32 dated February 9 has a relationship with each of the document data 32 dated February 11 and the document data 32 dated February 13, the second derivation unit 46 may check whether there is a relationship between the document data 32 dated February 11 and the document data 32 dated February 13. In a case where there is a relationship between the document data 32 dated February 11 and the document data 32 dated February 13, the second derivation unit 46 may delete the relationship between the document data 32 dated February 11, which is associated with the older date information, and the document data 32 dated February 9. In this case as well, the second derivation unit 46 may set the fact that the partial documents serving as the basis for the relationship are the same as the condition for deletion. That is, the second derivation unit 46 may set, as the condition for deletion, the fact that the partial document included in the document data 32 dated February 11, which indicates the relationship between the document data 32 dated February 9 and the document data 32 dated February 11, and the partial document included in the document data 32 dated February 13, which indicates the relationship between the document data 32 dated February 9 and the document data 32 dated February 13, are partial documents indicating the relationship between the document data 32 dated February 11 and the document data 32 dated February 13.

As shown in FIG. 9, the display control unit 48 performs control of displaying the overall document relationship information derived by the second derivation unit 46 on the display 23. FIG. 9 shows an example in which the pieces of document data 32 from which any one of (1) to (4) is derived as the partial document relationship information are connected by arrows, and a character string representing the category is displayed above each arrow. This character string may be an icon.

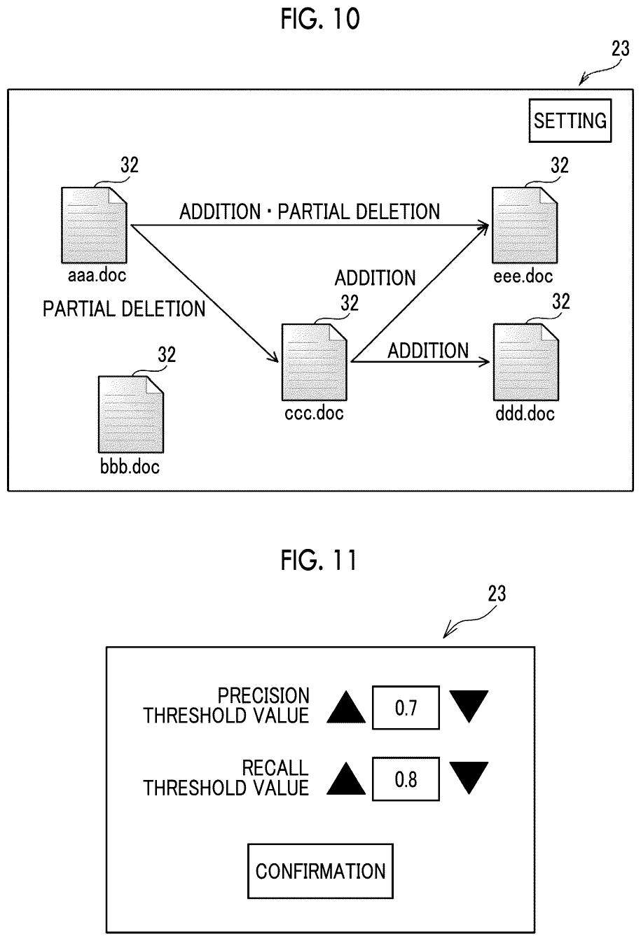

The threshold value used by the first derivation unit 44 for comparison with the precision or the threshold value used for comparison with the recall may be each set value determined in advance, or may be designated by the user. In other words, the display control unit 48 may perform control of displaying a display screen for the user to input the threshold value. For example, as shown in FIG. 10, the display control unit 48 performs control of further displaying a setting button on the display screen shown in FIG. 9. In a case where the user designates the setting button, the display control unit 48 performs control of displaying, for example, a threshold value setting screen shown in FIG. 11 on the display 23. The CPU 20 receives a threshold value change operation such as a user's numerical input of the threshold value and activation of a confirmation button on the threshold value setting screen. In a case where the threshold value change operation by the user is received, the first derivation unit 44 re-derives the partial document relationship information by using the changed threshold value, and the second derivation unit 46 re-derives the overall document relationship information again based on the re-derived partial document relationship information. The display control unit 48 performs control of displaying the re-derived overall document relationship information on the display 23 again.

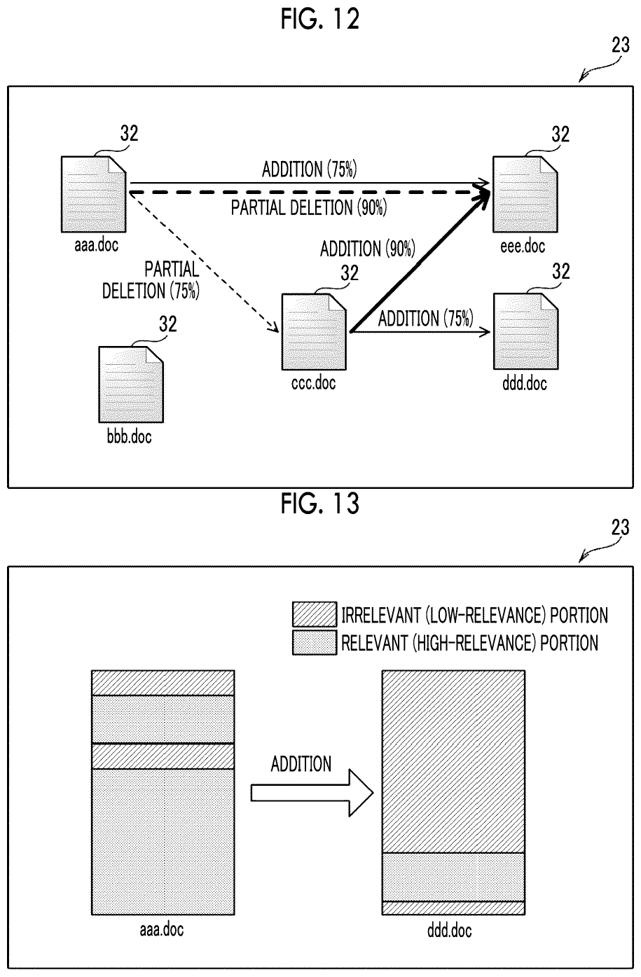

In addition, the first derivation unit 44 may derive a certainty for each piece of partial document relationship information based on the similarity between the partial documents. Specifically, the first derivation unit 44 may derive the certainty of the partial document relationship information based on a deviation from the threshold value of the precision or the recall between the partial documents. For example, the first derivation unit 44 may derive a precision deviation, which is a deviation from a threshold value in precision, and a recall deviation, which is a deviation from a threshold value in recall, and may derive the certainty of the partial document relationship information based on an integrated deviation based on the precision deviation and the recall deviation. In this case, the integrated deviation may be a deviation of at least one of a maximum value or an average value of the precision deviation and the recall deviation. In addition, the integrated deviation may be a numerical value obtained by performing any of addition or integration of the precision deviation and the recall deviation. In addition, the second derivation unit 46 may determine a target to be the overall document relationship information according to the certainty based on the similarity between the partial documents of the partial document relationship information. For example, as shown in FIG. 8, in a case where, for the “addition” relationship connecting February 9 and February 13, there exist a route A that goes through February 11 and a route B that connects them directly, the second derivation unit 46 may determine which of the routes is to be selected as the overall document relationship information depending on a route certainty indicating the certainty of each route. For example, in a case where the certainty of “addition” between February 9 and February 11 is A, the certainty of “addition” between February 11 and February 13 is B, and the certainty of “addition” between February 9 and February 13 is C, the second derivation unit 46 sets an average value or a maximum value of the certainty A and the certainty B as a route certainty A of the route A, and sets the certainty C as a route certainty B of the route B. The second derivation unit 46 may select only a route (route A in the example of FIG. 8) having a larger route certainty between the route certainty A and the route certainty B, as the overall document relationship information. In addition, in a case where an absolute value of a difference between the route certainty A and the route certainty B is less than a threshold value, the second derivation unit 46 may select all the routes as the overall document relationship information, and, in a case where the absolute value of the difference is equal to or greater than the threshold value, the second derivation unit 46 may select only the route having the route certainty with a larger value as the overall document relationship information. In addition, the display control unit 48 may change a display aspect of the overall document relationship information depending on the certainty. The display aspect includes, for example, any one of a color, a size, a thickness, or a type of a character or an icon such as an arrow, which indicates the overall document relationship information. Further, the display control unit 48 may display the certainty together with the overall document relationship information. FIG. 12 illustrates a case where the thickness of the arrow indicates a level of the certainty and the information on the certainty is displayed together with the overall document relationship information, but the information on the certainty may be displayed only in one case. In a case where there are a plurality of pieces of partial document relationship information between partial documents such as between aaa.doc and eee.doc in the example of FIG. 12, as shown in FIG. 12, the display control unit 48 may display arrows corresponding to the respective pieces of partial document relationship information, and may vary a thickness of the arrows depending on the certainty, or may set the thickness of the arrows to be uniform and display the certainty in the vicinity of the respective pieces of partial document relationship information. In addition, the display control unit 48 may change the display aspect depending on the category indicated by the partial document relationship information. For example, the display control unit 48 may make a color of an arrow connecting the partial documents different or a type of a line, such as a broken line or a solid line, different between “addition” and “partial deletion”.

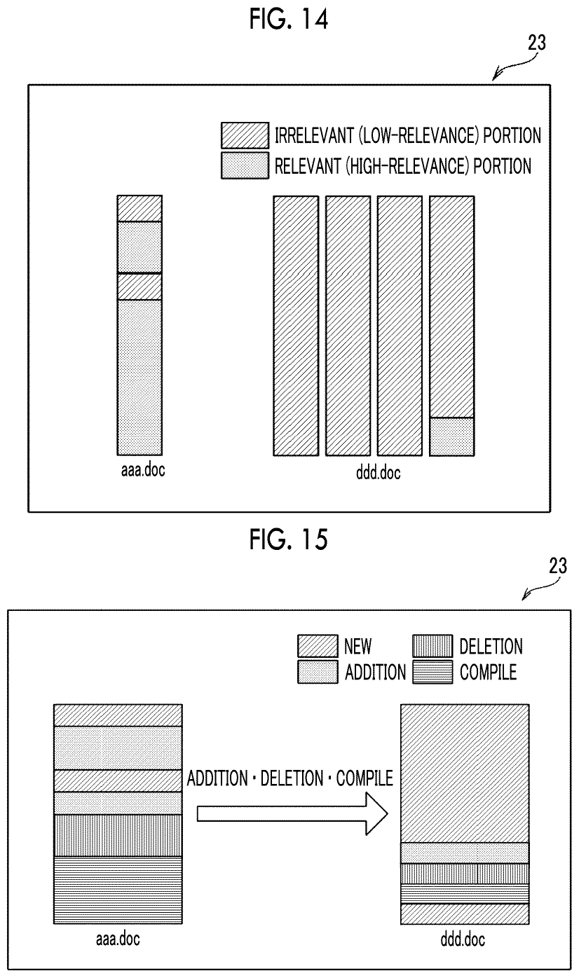

Further, the display control unit 48 may present degree-of-relationship information of the partial documents between the pieces of document data 32. The degree-of-relationship information may be information that indicates, with respect to the entirety of one piece of the document data 32, an amount of partial documents determined to be related to another piece of the document data 32. The presence or absence of the relationship between the partial documents may be determined, for example, based on whether or not the partial document is a partial document to which a category with the relationship is assigned by the first derivation unit 44. In addition, the amount of the partial documents may be the number of characters of the partial document or may be a number in units of sentences or paragraphs delimited by periods, commas, or the like. For example, in a case where 10 partial documents are included in the document data 32 of aaa.doc and there are 8 partial documents to which a category with a relationship “addition” or the like is assigned with respect to the partial documents included in the document data 32 of ddd.doc, the amount of the partial documents is 0.8 (=8/10). Meanwhile, in a case where 40 partial documents are included in the document data 32 of ddd.doc and there are 8 partial documents to which a category related to the document data 32 of aaa.doc is assigned, the amount of the partial documents is 0.2 (=8/40). The display control unit 48 displays the degree-of-relationship information together with the overall document relationship information, so that the user can more appropriately understand the relationship between the pieces of document data 32. In addition, the degree-of-relationship information may be information that indicates, with respect to the entirety of one piece of the document data 32, a position of a partial document to which a category related to another piece of the document data 32 is assigned. For example, as shown in FIG. 13, in the example described above, in a case where the relevant partial documents in aaa.doc are the second, third, and fifth to tenth documents counting from the beginning, the display control unit 48 may perform control of displaying, in a different display aspect, a rectangle corresponding to positions of the second, third, and fifth to tenth relevant partial documents and a rectangle corresponding to positions of the first and fourth irrelevant partial documents among rectangles indicating the document data 32 of aaa.doc. In addition, as shown in FIG. 13, in a case where the relevant partial documents in ddd.doc are the 31st to 38th partial documents counting from the beginning, the display control unit 48 may perform control of displaying, in a different display aspect, a rectangle corresponding to positions of the 31st to 38th relevant partial documents and a rectangle corresponding to positions of the first to 30th, 39th, and 40th irrelevant partial documents among rectangles indicating ddd.doc. In the example of FIG. 13, an icon indicating the document data 32 is divided by horizontal lines according to the overall amount of the partial document to indicate the positions of relevant partial documents, but it may also be divided in a different direction, such as by vertical lines. In addition, as shown in FIG. 14, the display control unit 48 may change a display aspect of an icon or the like indicating the document data 32 such that a difference in the total amount of the partial documents that do or do not have relevance in the document data 32 is recognized. In addition, the display control unit 48 may perform control of displaying at least one of an amount or a position of the partial documents, with respect to the partial document relationship information derived by the first derivation unit 44 or the overall document relationship information derived by the second derivation unit 46. For example, as shown in FIG. 15, the display control unit 48 may perform control of displaying, between aaa.doc and ddd.doc, the amount and the position of the partial documents in aaa.doc and ddd.doc that contribute to the determination of addition or the like such that the amount and the position are recognized.

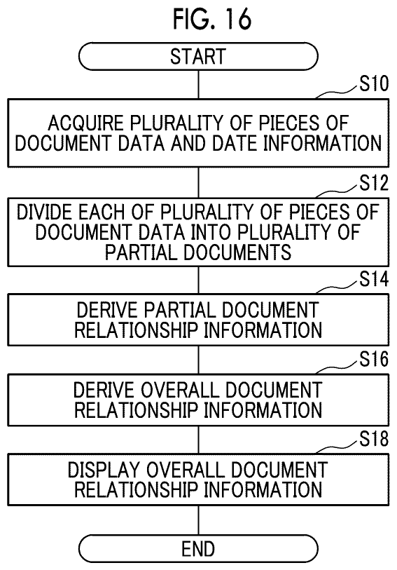

Next, an action of the information processing apparatus 10 will be described with reference to FIG. 16. The CPU 20 executes the information processing program 30 to execute a relationship information derivation process shown in FIG. 16. The relationship information derivation process shown in FIG. 16 is executed, for example, in a case where an instruction to start execution is input by the user.

In step S10 of FIG. 16, the acquisition unit 40 acquires the plurality of pieces of document data 32 and the date information associated with each of the plurality of pieces of document data 32 from the storage unit 22. In step S12, the division unit 42 divides each of the plurality of pieces of document data 32 acquired in step S10 into a plurality of partial documents.

In step S14, as described above, the first derivation unit 44 derives partial document relationship information representing a relationship between the partial documents, based on a similarity between the partial documents divided in step S12 and the date information, among the plurality of pieces of document data 32 acquired in step S10.

In step S16, as described above, the second derivation unit 46 derives overall document relationship information representing an overall relationship among the plurality of pieces of document data 32 based on the partial document relationship information derived in step S14. In step S18, as described above, the display control unit 48 performs control of displaying, on the display 23, the overall document relationship information in step S16. In a case where the process of step S18 ends, the relationship information derivation process ends.

As described above, according to the present embodiment, since the relationship information is derived for each partial document between the pieces of document data, it is possible to associate the plurality of pieces of document data with high precision.

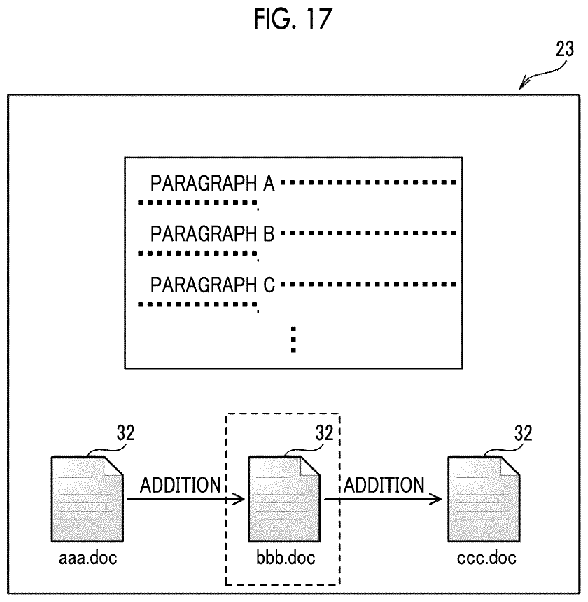

In the above-described embodiment, the CPU 20 may receive a selection of the document data 32 by the user. In this case, as shown in FIG. 17, in a case of performing control of displaying the overall document relationship information, the display control unit 48 may perform control of displaying, among the plurality of pieces of document data 32, only the selected document data 32 and the document data 32 derived to have a relationship with the selected document data 32 as the partial document relationship information on the display 23. Further, the display control unit 48 may perform control of displaying the content of the selected document data 32 on the display 23. In the example of FIG. 17, an example in which the document data 32 surrounded by a rectangular broken line is selected is shown.

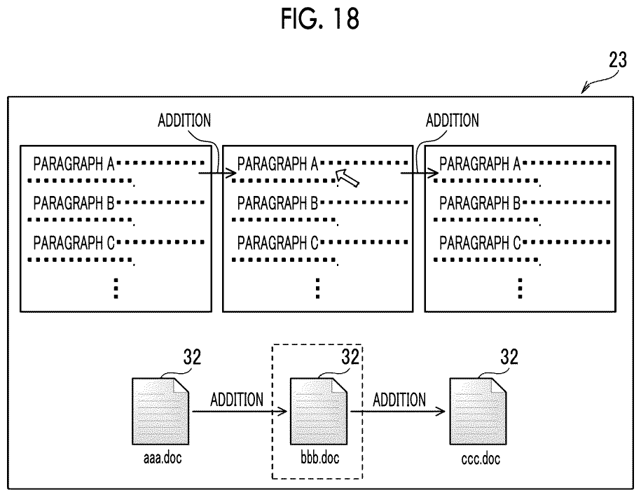

In addition, in the above-described embodiment, the CPU 20 may receive a selection of the partial document included in the document data 32 by the user. In this case, as shown in FIG. 18, the display control unit 48 may perform control of displaying, among the plurality of pieces of document data 32, only the document data 32 including the selected partial document and the document data 32 including the partial document derived to have a relationship with the selected partial document as the partial document relationship information. FIG. 18 shows an example in which “paragraph A” at a location indicated by an arrow icon is selected, and only the document data 32 including a paragraph derived to have a relationship with the “paragraph A” is displayed.

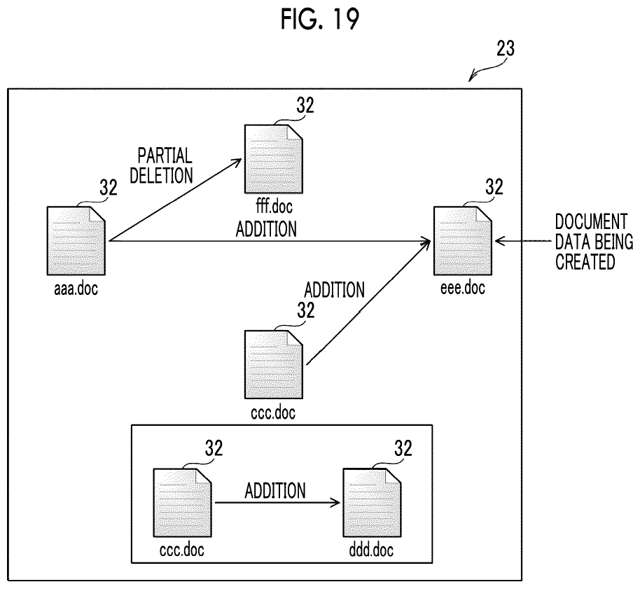

In addition, as shown in FIG. 19, in a case of performing control of displaying the overall document relationship information, the CPU 20 may perform control of displaying, among the plurality of pieces of document data 32, the document data 32 that is related to the selected document data 32 but is derived to have no relationship with the selected document data 32 as the partial document relationship information. In the example of FIG. 19, the document data 32 being created by the user corresponds to the selected document data 32. In addition, in the example of FIG. 19, the document data 32 that is related to the document data 32 being created by the user but is derived to have no relationship with the selected document data 32 as the partial document relationship information is highlighted by a rectangular frame line. In addition, examples of the document data 32 for which the relationship with the document data 32 selected by the user is determined include document data 32 describing the same patient as the document data 32 selected by the user in a case where the document data 32 is a medical document. In addition, examples of the document data 32 for which the relationship with the document data 32 selected by the user is determined include data stored in the same folder as the document data 32 selected by the user. As described above, the CPU 20 can extract the document data 32 for which the relationship with the document data 32 selected by the user is determined in accordance with at least one of attribute information or a storage destination of the document data 32. As a result, the user can ascertain whether or not there is a missing description in a case of creating the document data 32 that compiles the plurality of pieces of document data 32, for example.

In addition, in the above-described embodiment, for example, various processors shown below can be used as a hardware structure of a processing unit that executes various kinds of processing, such as each functional unit of the information processing apparatus 10. The various processors include, as described above, in addition to a CPU, which is a general-purpose processor that functions as various processing units by executing software (program), a programmable logic device (PLD) that is a processor of which a circuit configuration may be changed after manufacture, such as a field programmable gate array (FPGA), and a dedicated electrical circuit which is a processor having a circuit configuration specially designed to execute specific processing, such as an application specific integrated circuit (ASIC).

One processing unit may be configured of one of the various processors, or may be configured of a combination of the same or different kinds of two or more processors (for example, a combination of a plurality of FPGAs or a combination of the CPU and the FPGA). In addition, a plurality of processing units may be configured of one processor.

As an example in which a plurality of processing units are configured of one processor, first, as typified by a computer such as a client or a server, there is an aspect in which one processor is configured of a combination of one or more CPUs and software, and this processor functions as a plurality of processing units. Second, as typified by a system on chip (SoC) or the like, there is an aspect in which a processor that implements functions of the entire system including the plurality of processing units via one integrated circuit (IC) chip is used. As described above, various processing units are configured by using one or more of the various processors as a hardware structure.

Further, as the hardware structure of the various processors, more specifically, an electric circuit (circuitry) in which circuit elements such as semiconductor elements are combined may be used.

In addition, in the embodiment described above, an aspect has been described in which the information processing program 30 is stored (installed) in the storage unit 22 in advance, but the present disclosure is not limited to this. The information processing program 30 may be provided in a form of being recorded in a recording medium such as a compact disc read only memory (CD-ROM), a digital versatile disc read only memory (DVD-ROM), and a Universal Serial Bus (USB) memory. Further, the information processing program 30 may be downloaded from an external apparatus via a network.

The disclosure of JP2023-058030 filed on Mar. 31, 2023 is incorporated herein by reference in its entirety. In addition, all literatures, patent applications, and technical standards described herein are incorporated by reference to the same extent as if each individual literature, patent application, and technical standards were specifically and individually stated to be incorporated by reference.

The following appendices are further disclosed with respect to the above embodiment.

### (Appendix 1)

An information processing apparatus comprising:
at least one processor,
in which the processor is configured to
   acquire a plurality of pieces of document data, each including a plurality of partial documents, and date information associated with each of the plurality of pieces of document data,
   derive partial document relationship information representing a relationship between the partial documents, based on a similarity between the partial documents and the date information, among the plurality of pieces of document data, and
   derive overall document relationship information representing an overall relationship among the plurality of pieces of document data, based on the partial document relationship information.

### (Appendix 2)

The information processing apparatus according to Appendix 1,
in which the processor is configured to divide each of the plurality of pieces of document data into the plurality of partial documents.

### (Appendix 3)

The information processing apparatus according to Appendix 1 or 2,
in which the similarity includes a precision and a recall between the partial documents.

### (Appendix 4)

The information processing apparatus according to any one of Appendices 1 to 3,
in which the processor is configured to derive any one of a plurality of categories representing the relationship between the partial documents as the partial document relationship information.

### (Appendix 5)

The information processing apparatus according to any one of Appendices 1 to 4,
in which the processor is configured to, as the partial document relationship information, in a case where it is derived that one piece of the document data has a relationship with the plurality of pieces of document data and that relationships also exist among the plurality of pieces of document data, delete a relationship derived based on a relatively low similarity among the relationships between the one piece of document data and the plurality of pieces of document data.

### (Appendix 6)

The information processing apparatus according to any one of Appendices 1 to 5,
in which the processor is configured to perform control of displaying the overall document relationship information.

### (Appendix 7)

The information processing apparatus according to Appendix 6,
in which the processor is configured to
   receive selection of the document data, and
   in a case of performing control of displaying the overall document relationship information, perform control of displaying, among the plurality of pieces of document data, only the selected document data and the document data derived to have a relationship with the selected document data as the partial document relationship information.

### (Appendix 8)

The information processing apparatus according to any one of Appendices 1 to 5,
in which the processor is configured to
   receive selection of the partial document included in the document data, and
   perform control of displaying, among the plurality of pieces of document data, only the document data including the selected partial document and the document data including the partial document derived to have a relationship with the selected partial document as the partial document relationship information.

### (Appendix 9)

The information processing apparatus according to Appendix 6,
in which the processor is configured to
   receive selection of the document data, and
   in a case of performing control of displaying the overall document relationship information, perform control of highlighting, among the plurality of pieces of document data, the document data that is related to the selected document data but is derived to have no relationship with the selected document data as the partial document relationship information.

### (Appendix 10)

An information processing method executed by a processor provided in an information processing apparatus, the information processing method comprising:
acquiring a plurality of pieces of document data, each including a plurality of partial documents, and date information associated with each of the plurality of pieces of document data;
deriving partial document relationship information representing a relationship between the partial documents, based on a similarity between the partial documents and the date information, among the plurality of pieces of document data; and
deriving overall document relationship information representing an overall relationship among the plurality of pieces of document data, based on the partial document relationship information.

### (Appendix 11)

An information processing program for causing a processor provided in an information processing apparatus to execute:
acquiring a plurality of pieces of document data, each including a plurality of partial documents, and date information associated with each of the plurality of pieces of document data;
deriving partial document relationship information representing a relationship between the partial documents, based on a similarity between the partial documents and the date information, among the plurality of pieces of document data; and
deriving overall document relationship information representing an overall relationship among the plurality of pieces of document data, based on the partial document relationship information.

What is claimed is:

1. An information processing apparatus comprising:
at least one processor,
wherein the processor is configured to
acquire a plurality of pieces of document data, each including a plurality of partial documents, and date information associated with each of the plurality of pieces of document data,
derive partial document relationship information representing a relationship between the partial documents, based on a similarity between the partial documents and the date information, among the plurality of pieces of document data, and
derive overall document relationship information representing an overall relationship among the plurality of pieces of document data, based on the partial document relationship information.

2. The information processing apparatus according to claim 1,
wherein the processor is configured to divide each of the plurality of pieces of document data into the plurality of partial documents.

3. The information processing apparatus according to claim 1,
wherein the similarity includes a precision and a recall between the partial documents.

4. The information processing apparatus according to claim 1,
wherein the processor is configured to derive any one of a plurality of categories representing the relationship between the partial documents as the partial document relationship information.

5. The information processing apparatus according to claim 1,
wherein the processor is configured to, as the partial document relationship information, in a case where it is derived that one piece of the document data has a relationship with the plurality of pieces of document data and that relationships also exist among the plurality of pieces of document data, delete a relationship derived based on a relatively low similarity among the relationships between the one piece of document data and the plurality of pieces of document data.

6. The information processing apparatus according to claim 1,
wherein the processor is configured to perform control of displaying the overall document relationship information.

7. The information processing apparatus according to claim 6,
wherein the processor is configured to
receive selection of the document data, and
in a case of performing control of displaying the overall document relationship information, perform control of displaying, among the plurality of pieces of document data, only the selected document data and the document data derived to have a relationship with the selected document data as the partial document relationship information.

8. The information processing apparatus according to claim 1,
wherein the processor is configured to
receive selection of the partial document included in the document data, and
perform control of displaying, among the plurality of pieces of document data, only the document data including the selected partial document and the document data including the partial document derived to have a relationship with the selected partial document as the partial document relationship information.

9. The information processing apparatus according to claim 6,
wherein the processor is configured to
receive selection of the document data, and
in a case of performing control of displaying the overall document relationship information, perform control of highlighting, among the plurality of pieces of document data, the document data that is related to the selected document data but is derived to have no relationship with the selected document data as the partial document relationship information.

10. An information processing method executed by a processor provided in an information processing apparatus, the information processing method comprising:
acquiring a plurality of pieces of document data, each including a plurality of partial documents, and date information associated with each of the plurality of pieces of document data;
deriving partial document relationship information representing a relationship between the partial documents, based on a similarity between the partial documents and the date information, among the plurality of pieces of document data; and
deriving overall document relationship information representing an overall relationship among the plurality of pieces of document data, based on the partial document relationship information.

11. A non-transitory computer-readable storage medium storing an information processing program for causing a processor provided in an information processing apparatus to execute:
acquiring a plurality of pieces of document data, each including a plurality of partial documents, and date information associated with each of the plurality of pieces of document data;
deriving partial document relationship information representing a relationship between the partial documents, based on a similarity between the partial documents and the date information, among the plurality of pieces of document data; and
deriving overall document relationship information representing an overall relationship among the plurality of pieces of document data, based on the partial document relationship information.
